(19) United States
(12) Patent Application Publication
(10) Pub. No.: US 2008/0140327 A1
(43) Pub. Date: Jun. 12, 2008

(54) Method For Controlling the Electrical Energy Quality in an Electrical Power Supply System

(75) Inventors: Uwe Anklam, Kammerstein (DE); Manfred Unterweger, Stein (DE)

Correspondence Address: LERNER GREENBERG STEMER LLP, P O BOX 2480, HOLLYWOOD, FL, 33022-2480, US

(73) Assignee: Siemens Aktiengesellschaft, Munchen (DE)

(21) Appl. No.: 11/665,314

(22) PCT Filed: Sep. 20, 2005
(86) PCT No.: PCT/EP05/54683

§ 371 Date: Apr. 13, 2007

(30) Foreign Application Priority Data
Oct. 13, 2004 (DE) 10 2004 050 455.5

(51) Int. Cl. H02J 3/01

(52) U.S. Cl. 702/60

(57) ABSTRACT

A method for controlling the quality of the electrical energy of an electrical power supply system, which allows the quality of the electrical energy to be controlled so as to correspond largely to the required threshold values. The method comprises the following steps: a first test curve of measured values of a parameter which indicates the quality of the electrical energy of the power supply system is detected during a first observation period; a first pattern recognition is performed regarding the first test curve in order to generate a user profile which indicates expected time-related deviations of the parameter from a predefined setpoint range for at least one future observation period based of patterns recognized in the first test curve; and measures that stabilize the quality of the electrical energy are taken for the times of the future observation period during which a deviation of the parameter from the setpoint range is expected to occur according to the user profile.

Nowadays, electrical power supply systems represent highly complex networks for distribution of electrical power, and often have a large number of power feeds and outlets. In addition to supply reliability, that is to say ensuring that a sufficient amount of electrical power is available for every power load at all times, the quality of the electrical power supplied (electrical power quality) also plays a major role. The electrical power quality in the power supply system can be defined, for example, using characteristic variables such as frequency, voltage and harmonic content. Highly sensitive electrical appliances nowadays demand an electrical power supply in the form of a sine wave which is as pure as possible, is at a uniform amplitude and has a uniform frequency. Standardization documents such as EN 50160 or IEC 61000 therefore specify upper and lower limit values within which these characteristic variables of the electrical power quality of a power supply system must lie. If the limit values are not complied with for a relatively long time, then the electrical power consumers may demand compensation from the power supply system operator. The standards normally define a maximum time period for this purpose, during which the characteristic variables of the electrical power quality may be outside the required limit values without consumers being able to demand compensation. For example, it is possible to provide for the electrical power quality to be only up to 5% outside the required limit values within a time period under consideration of, for example, one year. The network operators are therefore required to supply electrical power with as high a quality as possible.

However, since the electrical power quality may be dependent on the behavior and the nature of major disturbances from electrical loads connected to the power supply system, it has so far not been possible to reliably preclude fluctuations in the electrical power quality.

In order to allow statements to be made about the electrical power quality, test equipment is provided at various measurement points in the electrical power supply system, recording measured values of the respective characteristic variables of the electrical power quality. These characteristic variables are then evaluated, for example by data processing facilities connected to the test equipment. Time-dependent profiles of the characteristic variables can thus be produced, and compliance with the limit values checked and verified. A procedure such as this is known, for example, from German Patent Specification DE 199 24 550 C2, on the basis of which characteristic variables are recorded and preprocessed at various points in a power supply system. The recorded characteristic variables can then be evaluated and assessed by a shared data processing facility. However, a procedure such as this can be used only to describe the previous behavior of the electrical power quality, and planned intervention with the electrical power quality is not provided here.

The invention is based on the object of specifying a method for controlling the electrical power quality in an electrical power supply system, by means of which it is possible to comply as well as possible with specified limit values for the electrical power quality.

In order to achieve this object, a method is proposed for controlling the electrical power quality in a power supply system, in which the following steps are carried out: first of all, a first measurement profile of the measured values of a characteristic variable which indicates the electrical power quality in the power supply system, is recorded during a first observation time period; a pattern recognition process is carried out on this first measurement profile, resulting in a load profile which, on the basis of patterns recognized in the first measurement profile, indicates time-related discrepancies expected for at least one future observation period in the characteristic variable from a predeterminable nominal range; measures are then taken to stabilize the electrical power quality for those times in the future observation time period in which a discrepancy between the characteristic variable and the nominal range is expected on the basis of the load profile.

The major advantage of the method according to the invention is that the pattern recognition process can be used to make a statement about the probable future behavior of the electrical power quality. This is because a measurement profile is first of all recorded which indicates the time profile of a specific characteristic variable which is characteristic of the electrical power quality, such as the frequency, amplitude, root mean square current and voltage values, harmonic content, power, wattless component and volt-amperes, as well as balancing of the phase voltages and currents in the power supply system. The recorded measurement profile is then examined for characteristic patterns. For example, fluctuations in a characteristic variable which occur repeatedly at specific times of day are identified here. Recognized patterns such as these are used to derive a load profile, on the basis of which measures for stabilization of the electrical power quality are taken in future observation time periods for those times in which discrepancies between the characteristic variable—and therefore the electrical power quality—and a nominal range are expected on the basis of the load profile. This nominal range is normally predetermined in a tighter form than is necessary as a result of the limit values specified by the standard, so that it is even possible to recognize more minor fluctuations in the electrical power quality. In the extreme, the nominal range may also be a single nominal value; in this case, not only the considerable fluctuations, but any discrepancies in the characteristic variable are taken into account in the pattern recognition process, and the formation of the load profile. However, the pattern recognition process can be used not only to identify previous behavior patterns, it can also in fact be used to derive trends from the behavior of the load profile in order to determine the probable future behavior of the electrical power quality more precisely. This makes it possible to produce a relatively good estimate of the future behavior of the electrical power quality in the power supply system.

In order to allow the future behavior of the electrical power quality in the power supply system to be estimated even more accurately, one advantageous embodiment of the method according to the invention proposes that at least one further measurement profile of the measured values of the characteristic variable which indicates the electrical power quality of the power supply system be recorded during at least one further observation time period, following the first observation time period; the at least one further measurement profile is attached to the first measurement profile, resulting in a correspondingly longer combined measurement profile, and the pattern recognition process is carried out on the combined measurement profile, resulting in the load profile.

This allows continuous dynamic adaptation of the load profile to be carried out on the basis of the measurement profiles recorded in the respective observation time periods. In general, it can be assumed that any estimate of the future profile of the characteristic variable will become more accurate the greater the number of observation time periods that are available as a basis. Furthermore, according to this embodiment, a developing trend in the profile of the characteristic variable—and therefore in the electrical power quality—can be indicated even more accurately. This because differences in the behavior of the electrical power quality in a plurality of successive observation time periods can be used to derive a developing trend for the electrical power quality for future observation time periods.

In general, the observation time periods during which the measured values of the characteristic variable are recorded, may, for example, have a duration of one day, one week, one month or one year. Other observation time period durations should not, however, be excluded from the scope of the method according to the invention.

By way of example, pattern recognition may include recognition of periodicities and/or autocorrelation of the recorded measured values. This allows regularly recurring events and characteristic patterns which influence the electrical power quality to be recognized, and to be included in the load profile.

Furthermore, one further advantageous embodiment of the method according to the invention provides for the pattern recognition process to access an electronic calendar and to correlate the electronic calendar with the measurement profile or the combined measurement profile. This makes it possible, for example, to recognize fluctuations in the electrical power quality which are dependent on the time of week, the time of month or the time of year to be recognized even better as such in the formation of the load profile. For example, this allows differences in the measurement profiles recorded on a daily basis to be related to days of the week and weekends.

A further advantageous embodiment also provides for measurement profiles of the characteristic variable to be recorded at a plurality of points in the power supply system, and for the respective load profiles to be determined on the basis of these measured values of a characteristic variable recorded at a plurality of points.

This allows the method according to the invention to particularly advantageously access not only measured values of the characteristic variable from a single measurement point in the power supply system, but in fact access measured values of the characteristic variable form a plurality of measurement points distributed over the power supply system, thus resulting in more comprehensive information about the overall power supply system.

In order to explain the invention in more detail:

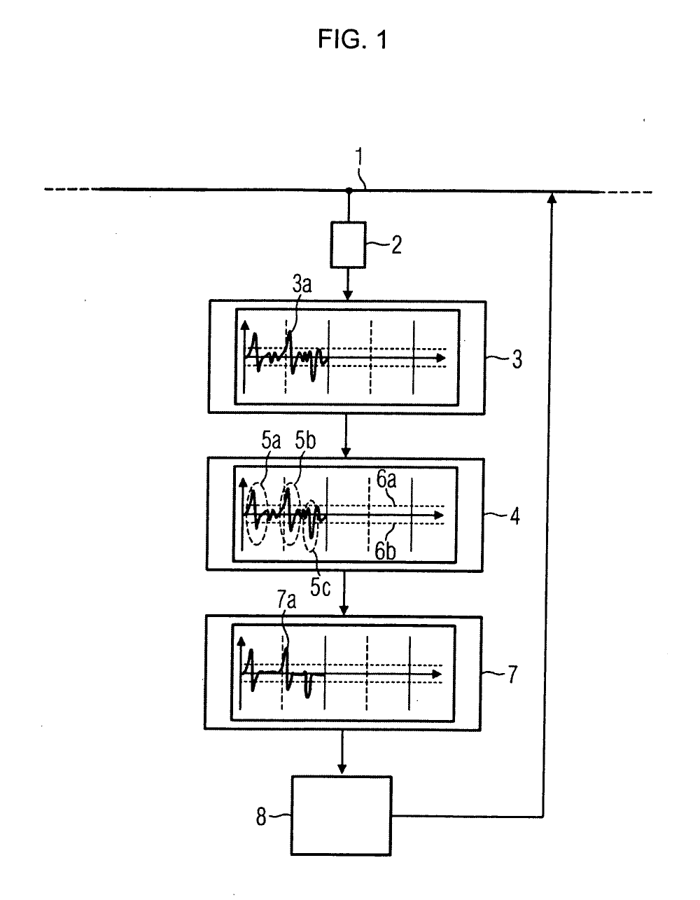

FIG. 1 shows a schematic illustration of one exemplary embodiment of a method for controlling the electrical power quality in a power supply system, in the form of a block diagram, and

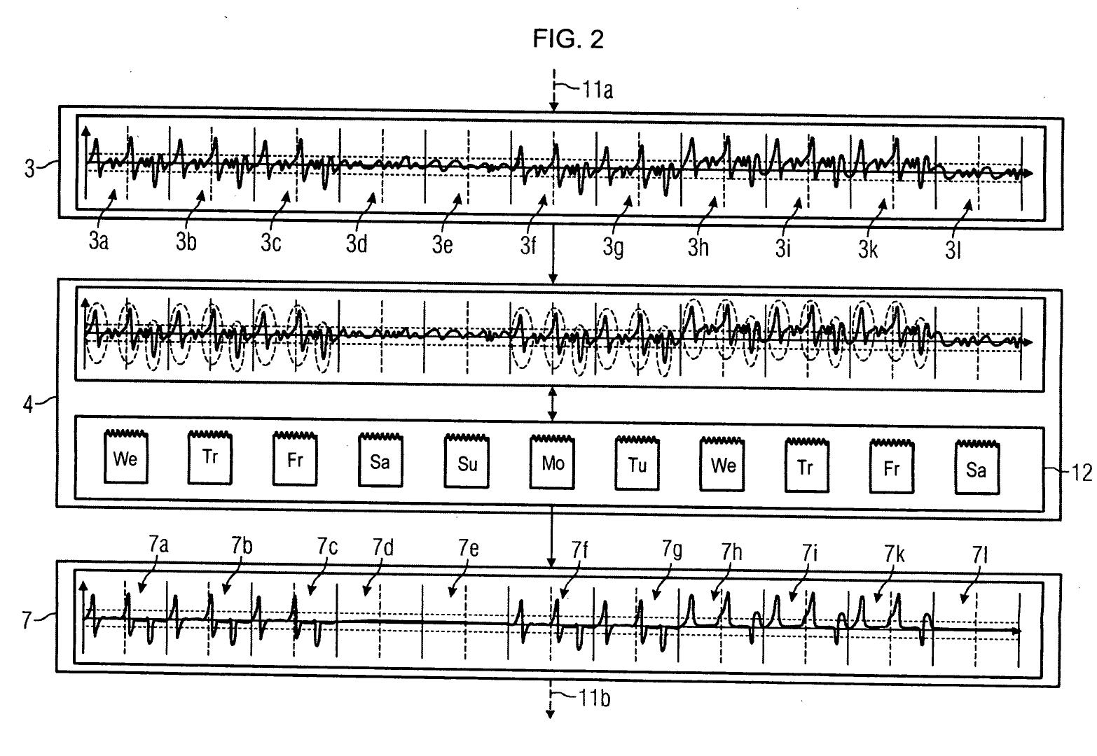

FIG. 2 shows a block diagram in order to explain a further exemplary embodiment of a method for controlling the electrical power quality in a power supply system.

By way of example, FIG. 1 shows a section 1 of a power supply line which is part of an electrical power supply system. Although the section 1 shown in FIG. 1 is illustrated as a single-phase section, it may in this case also be a section of a polyphase power supply line. A test set 2 is connected to the section 1 via sensors, which are only schematically indicated in FIG. 1, and records measured values of a characteristic variable over a predetermined observation time period, for example of one day, one week, one month or one year, with this characteristic variable being suitable for characterization of the electrical power quality in the electrical power supply system. One such characteristic variable, for example, may be the rout mean square value of the current or voltage, wattless component, volt-amperes and power, frequency, amplitude and harmonic content of the electrical power.

In a first method step 3, a first measurement profile 3a is produced from the recorded measured values of the characteristic variable. In this case, the illustrated exemplary embodiment is based on the assumption that this first measurement profile 3a was recorded during a first observation time period with a duration of one day. A pattern recognition process is carried out on this first measurement profile 3a, in a second method step 4. During the course of this pattern recognition process, the first measurement profile 3a is examined, for example, for periodically recurring or other conspicuous patterns. Patterns which have been recognized in this way are emphasized in FIG. 1 by ellipses 5a, 5b and 5c in the form of dashed lines. In this case, the two ellipses 5a and 5b mark a repetitive pattern in the first measurement profile 3a, while the ellipse 5c indicates a particularly conspicuous pattern in the first measurement profile—in this case a considerable fluctuation downward in the recorded characteristic variable. It is also possible to provide in the pattern recognition process for the only patterns that are considered to be those whose profiles are, at least at times, outside a nominal range which is bounded by dotted lines 6a and 6b. The choice of this nominal range will normally lie within limit values specified by particular standards for permissible discrepancies in the corresponding characteristic variable for the electrical power quality, in order to recognize discrepancies at this stage even before there is any risk of the limit value being infringed. In the extreme, the nominal range defined by the dotted lines 6a and 6b may also cover only one nominal value. In this case, the pattern recognition process will take account of even relatively minor fluctuations, such as those which occur, for example, in the first measurement profile 3a between the patterns emphasized by the ellipses 5a, 5b and 5c.

A load profile 7a which indicates a probable future behavior of the electrical power quality in subsequent observation time periods, that is to say on the following day in the example shown in FIG. 1, with respect to the previously recorded measured values of the characteristic variable of the first measurement profile 3a is generated on the basis of the pattern recognized in the second method step 4, in the third method step 7 which now follows. Only those discrepancies in the characteristic variable of the first measurement profile which are outside the nominal range are taken into account in the illustrated load profile.

This load profile 7a is used by a control block 8 to take active measures relating to the power supply system, by in each case taking measures in future observation time periods for stabilization of the electrical power quality of the power supply system when discrepancies in the characteristic variable from the nominal range are expected on the basis of the load profile 7a. Measures such as these for stabilization of the electrical power quality may be, for example, the use of active power supply system filters or power factor correctors; also provision of a bypass route, that is to say a change in the routing of the electrical power in the power distribution system via those lines on which there are only minor fluctuations in the electrical power quality can contribute to stabilization of the electrical power quality throughout the entire system.

The described method is in consequence used to make an estimate, on the basis of an assumed measurement profile, of the behavior of the electrical power quality in future observation time periods. This estimate is produced automatically by means of the pattern recognition process, during which, for example, the first measurement profile is examined for recurring, that is to say periodically occurring, patterns. Furthermore, an autocorrelation process can be carried out on the measurement profile. An autocorrelation process such as this is particularly suitable for recognition of specific, characteristic patterns in the measurement profile in measurement profiles which have been recorded over a relatively long time period, for example of one month.

In one embodiment, the described method can access measurement profiles which have been recorded at only a single point in the power supply system.

In another embodiment, however, it is also possible to provide a plurality of measurement points in the electrical power supply system so that a plurality of measurement profiles of the same measurement variable can be produced at the same time, and a pattern recognition process can be used to identify those patterns which occur in a distributed form over the entire power supply system. This allows the electrical power quality to be controlled for the entire system.

A further exemplary embodiment of a method for controlling the electrical power quality in the power supply system will be explained in more detail with reference to FIG. 2. For simplicity, FIG. 2 shows only the first 3, second 4 and third method steps 7 from FIG. 1; these illustrated method steps are, however, included in a method analogously to the method shown in FIG. 1, as is intended to be indicated by the arrows 11a and 11b, some of which are in the form of dashed lines, in FIG. 2.

In addition to the measurement profile 3a already recorded in FIG. 1, FIG. 2 shows further measurement profiles 3b to 3l which have each also been recorded over an observation time period of one day in the exemplary embodiment under consideration. In consequence, the second measurement profile 3b represents the profile of the characteristic variable on that day which follows the day described by the first measurement profile 3a. The measurement profiles 3c to 3l are accordingly linked thereto. The further measurement profiles 3b to 3l are attached to the first measurement profile 3a, and, together with it, form a combined measurement profile.

The combined measurement profile is examined by means of an automatic pattern recognition process in the second method step 4. Specific patterns can be recognized, analogously to FIG. 1, by the pattern recognition process in the element 3a of the combined measurement profile. Patterns such as these may be caused by specific electrical loads connected to the power supply system, for example by product machines, such as electrically driven stamps in a production company. Electrical stamps and other production machines such as these have a major influence on the electrical power quality, since, during operation, they increase the harmonic content of the electrical power in the power supply system, for example.

Specific behavior patterns such as these are recognized as recurring patterns by the pattern recognition process. As can be seen from analysis of the profile elements 3b and 3c of the combined measurement profile, the behavior of the element 3a also continues over the following days. The corresponding patterns are recognized again by the pattern recognition process, and this is reflected in the load profile created on the basis of the elements 7a to 7c.

Only minor fluctuations in the electrical power quality can be found, without any recognizable pattern, over the following days, which are characterized by the elements 3d and 3e of the combined measurement profile. At this point, it is advantageous for an electronic calendar 12 to be added to the pattern recognition process, and for the combined measurement profile to be correlated with the calendar 12. This is because, in a situation such as this, it is possible in the illustrated example for those elements with clearly recognizable patterns and fluctuations in the electrical power quality to occur on working days, while those elements 3d and 3e which have only minor fluctuations and no recognizable pattern to occur over a weekend, when the manufacturing company under consideration in this example has interrupted its production. Since those machines which can have major effects on the electrical power quality in the power supply system are in consequence not being operated over the weekend, there is scarcely any disturbance in the behavior of the electrical power quality.

The pattern recognition can use the information about the days of the week to create a load profile which in each case has a behavior such as that in the elements 3a to 3c of the combined time profile on working days, and essentially has a null profile at the weekend. This can be seen in the elements 7a to 7e of the load profile.

If those elements 3f and 3g of the combined time profile that now follow are considered, with these being those that occur on Monday and Tuesday, then this expected load behavior fits this very well. The production company runs its production machines in the same way as on the previous working days, as is evident in the same influences on the electrical power quality. The load profile therefore has elements 7f and 7g which correspond to the elements 7a to 7c.

Those elements 3h to 3k which now follow in the combined measurement profile exhibit a component which is additionally superimposed on the normal profile for days of the week, so that the overall measurement profile appears to be shifted upwards in these elements. In our example, this behavior may be caused by building-site activity taking place in the area of the power supply system, in which machines are used which have effects such as these on the electrical power quality of the power supply system, with the recorded measured values of the characteristic variable being superimposed in the manner illustrated in the areas 3h to 3k.

The pattern recognition can recognize just from the element 3i that this superimposition apparently relates to a relatively long-lasting disturbance in the electrical power quality, and the load profile can be appropriately adapted. The pattern recognition therefore indicates a developing trend, which also includes relatively long-lasting unpredicted events in the corresponding load profile, as the elements 7h to 7k. The element 3l once again shows that this relates to weekend operation and the machines in the production company and those at the building site are not being used, so that there is no particular disturbance in the electrical power quality.

In the exemplary embodiment described here, only a relatively short section of the development of the load profile has been described, for simplicity. In practice, in fact, load profiles such as these are created over relatively long time periods. However, the fundamental procedure is still as described.

The load profile derived in this way can then be used to control the electrical power quality in the power supply system. If the developed load profile matches the actual profile of the electrical power quality, then the fluctuations can be reduced by means of control based on the load profile, in such a manner that no limit values should be infringed. In this situation, recorded measured values of the characteristic variable in the observation time periods in which control is being carried out should assume a profile that is largely free of fluctuations.

If changes occur in the behavior of the electrical power quality that have not yet been taken into account in the load profile, then these are recognized by the fact that fluctuations can in fact once again be seen in the recorded measurement profiles. The load profile can then be appropriately adapted, analogously to the described procedure.

Analogously to the way in which it was possible to deduce a weekly behavior from the daily behavior of the electrical power quality in the illustrated example, a monthly behavior and an annual behavior can also be deduced from measurement profiles combined over even longer periods. It may be useful to use the electronic calendar 12 again for this purpose. By way of example, this allows a seasonal phenomena to be recognized, such as vacation times, in which a manufacturing company shuts down operations and the electrical drive machines are therefore largely stationary, or a change between summer and winter with different electrical loads connected to the electrical power supply system.

The described method therefore makes it possible to use recorded actual measurement profiles to deduce the future behavior of the electrical power quality in an electrical power distribution system. Pattern recognition is used to identify characteristic patterns, for example, from specific electrical loads which are connected to the power supply system at specific times. Furthermore, unpredicted events, such as a newly commencing building site, are also included in the pattern recognition process and, so to speak, a future profile is extrapolated. Even more accurate statements about the future load profiles can be made by inclusion of a calendar function in the pattern recognition. If a future load profile has been defined with sufficient accuracy, then it can be used to apply measures to the electrical power supply system in such a way as to stabilize the electrical power quality at the risk times.

1-7. (canceled)

8. A method of controlling a quality of an electrical energy in an electrical power supply system, which comprises the following steps:
recording, during a first observation time period, a first measurement profile of a measured values of a characteristic variable indicating the quality of the electrical energy in the power supply system;
carrying out a pattern recognition process on the first measurement profile, resulting in a load profile which, on the basis of patterns recognized in the first measurement profile, indicates time-related discrepancies expected for at least one future observation time period in the characteristic variable from a predetermined nominal range; and
taking measures to stabilize the quality of the electrical energy for those times in the future observation time period in which a discrepancy between the characteristic variable and the nominal range is expected based on a load profile.

9. The method according to claim 8, which further comprises the following steps:
recording, during at least one further observation time period following the first observation time period, at least one further measurement profile of the measured values of the characteristic variable indicating the quality of the electrical energy of the power supply system;
attaching the at least one further measurement profile to the first measurement profile, resulting in a correspondingly longer combined measurement profile; and
carrying out the pattern recognition process on the combined measurement profile, resulting in the load profile.

10. The method according to claim 8, which comprises recording the measured values of the characteristic variable during an observation time period substantially having a duration selected from the group consisting of one day, one week, one month, and one year.

11. The method according to claim 9, which comprises examining the measurement profile or the combined measurement profile for periodicities during the pattern recognition process.

12. The method according to claim 9, which comprises subjecting the measurement profile or the combined measurement profile to autocorrelation during the pattern recognition process.

13. The method according to claim 8, which comprises examining the measurement profile for periodicities during the pattern recognition process.

14. The method according to claim 8, which comprises subjecting the measurement profile to autocorrelation during the pattern recognition process.

15. The method according to claim 8, wherein the pattern recognition process accesses an electronic calendar, and the pattern recognition process correlates the electronic calendar with the measurement profile or the combined measurement profile.

16. The method according to claim 8, which comprises recording measurement profiles of the characteristic variable simultaneously at a plurality of points in the power supply system, and determining the load profile on a basis of the measurement profiles recorded at a plurality of points.
